(19) United States
(12) Patent Application Publication
(10) Pub. No.: US 2009/0327956 A1
(43) Pub. Date: Dec. 31, 2009

(54) Apparatus and method for enabling user input

(75) Inventor: Ofri Olavi Porat, Tampere (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/215,618

(22) Filed: Jun. 27, 2008

(51) Int. Cl. G06F 3/048

(52) U.S. Cl. 715/810

(57) ABSTRACT

A method, apparatus, computer program and user interface wherein the method includes providing a plurality of selectable control elements where the plurality of selectable control elements are sorted into categories according to a first sorting criterion and sorted into positions within the categories according to a second sorting criterion; controlling a display to present a first one of the plurality of selectable control elements wherein the first one of the selectable control elements is positioned in a determined category at a determined position within the determined category; enabling a user to control the display to present a second one of the plurality of selectable control elements by enabling a first type of directional user input to select a different category and enabling a second type of directional user input to select a position within the selected category without changing the selected category.

### FIELD OF THE INVENTION

Embodiments of the present invention relate to an apparatus, method, computer program and user interface for enabling access to content. In particular, they relate to an apparatus, method, computer program and user interface for enabling access to a particular piece of content stored with a plurality of other pieces of content.

### BACKGROUND TO THE INVENTION

Apparatus and methods for storing and enabling access to a plurality of pieces of content such as electronic audio files are known. When a user of such an apparatus wishes to access a particular piece of content it can be time consuming for the user to find the particular content as they may have to navigate through a complicated menu structure or scroll through a long list of content. This may be particularly inconvenient in apparatus where the user input interface is limited, for example in hand held communication devices where the amount of space available for the display and user input device is limited by the size of the apparatus.

### BRIEF DESCRIPTION OF VARIOUS EMBODIMENTS OF THE INVENTION

According to various, but not necessarily all, embodiments of the invention there is provided a method comprising: providing a plurality of selectable control elements where the plurality of selectable control elements are sorted into categories according to a first sorting criterion and sorted into positions within the categories according to a second sorting criterion; controlling a display to present a first one of the plurality of selectable control elements wherein the first one of the selectable control elements is positioned in a determined category at a determined position within the determined category; enabling a user to control the display to present a second one of the plurality of selectable control elements by enabling a first type of directional user input to select a different category and enabling a second type of directional user input to select a position within the selected category without changing the selected category.

This provides the advantage that a user can quickly and easily find a particular piece of content by selecting a category and then selecting a position within that category. Once the user has found the appropriate selectable control element they can then easily access the content by selecting the selectable control element.

As different types of directional user inputs are used to select categories than to select positions within a category this provides a method of accessing content which is both intuitive to a user and efficient for a user to use.

According to some embodiments of the invention the selectable control element may enable access to content. The content may comprise audio information.

According to some embodiments of the invention the selectable control elements may comprise an image corresponding to the content.

According to some embodiments of the invention the selectable control elements may comprise a label indicative of the content associated with the selectable control element. The first sorting criterion may be alphabetical order of the first character in the label. The second sorting criterion may be the alphabetical order of second and subsequent characters in the label.

According to some embodiments of the invention in response to selection of the selectable control element information relating to the content may be presented.

According to some embodiments of the invention the directional inputs may be trace inputs on a touch sensitive user input device.

According to various, but not necessarily all, embodiments of the invention there is provided an apparatus comprising: a display configured to present a first one of a plurality of selectable control elements where the plurality of selectable control elements are sorted into categories according to a first sorting criterion and sorted into positions within the categories according to a second sorting criterion and where the first one of the plurality of selectable control elements is positioned in a determined category at a determined position within the determined category; a user input device configured to enable a user to make directional user inputs; and a processor configured to control the display to present a second one of the plurality of selectable control elements by selecting, in response to a first type of directional user input, a different category and selecting, in response to a second type of directional user input, a position within the selected category without changing the selected category.

According to various, but not necessarily all, embodiments of the invention there is provided a computer program comprising program instructions for controlling an apparatus, the apparatus comprising a user input device configured to enable a user to make directional user inputs and a display, the program instructions providing, when loaded into a processor: means for controlling the display to present a first one of a plurality of selectable control elements where the plurality of selectable control elements are sorted into categories according to a first sorting criterion and sorted into positions within the categories according to a second sorting criterion and where the first one of the plurality of selectable control elements is positioned in a determined category at a determined position within the determined category; and means for controlling the display to present a second one of the plurality of selectable control elements by selecting, in response to a first type of directional user input, a different category and selecting, in response to a second type of directional user input, a position within the selected category without changing the selected category.

According to various, but not necessarily all, embodiments of the invention there is provided a user interface comprising: a display configured to present a first one of a plurality of selectable control elements where the plurality of selectable control elements are sorted into categories according to a first sorting criterion and sorted into positions within the categories according to a second sorting criterion and where the first one of the plurality of selectable control elements is positioned in a determined category at a determined position within the determined category; a user input device configured to enable a user to make directional user inputs; wherein the user interface is configured such that the display is controlled to present a second one of the plurality of selectable control elements by selecting, in response to a first type of directional user input, a different category and selecting, in response to a second type of directional user input, a position within the selected category without changing the selected category.

The apparatus may be for wireless communication.

### BRIEF DESCRIPTION OF THE DRAWINGS

For a better understanding of various examples of embodiments of the present invention reference will now be made by way of example only to the accompanying drawings in which:

FIG. 1 schematically illustrates an electronic apparatus;

FIG. 2 illustrates a flow chart showing method blocks of an embodiment of the present invention;

FIGS. 3A to 3D illustrate a graphical user interface according to a first embodiment the present invention;

FIGS. 4A to 4B illustrate a graphical user interface according to a second embodiment of the present invention; and

FIGS. 5A to 5C illustrate a graphical user interface according to a third embodiment the present invention.

### DETAILED DESCRIPTION OF VARIOUS EMBODIMENTS OF THE INVENTION

The Figures illustrate a method comprising: providing 21 a plurality of selectable control elements 42, 64, 72 where the plurality of selectable control elements 42, 64, 72 are sorted into categories according to a first sorting criterion and sorted into positions within the categories according to a second sorting criterion; controlling a display 11 to present 23 a first one of the plurality of selectable control elements 42 wherein the first one 42 of the selectable control elements is positioned in a determined category at a determined position within the determined category; enabling a user to control the display 11 to present 29 a second one 64, 72 of the plurality of selectable control elements 64 by enabling a first type of directional user input to select a different category and enabling a second type of directional user input to select a position within the selected category without changing the selected category.

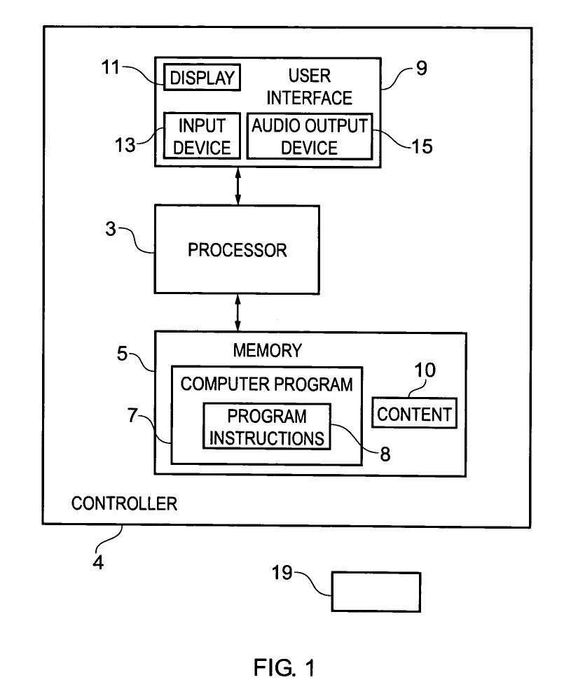

FIG. 1 schematically illustrates an electronic apparatus 1. Only the features referred to in the following description are illustrated. It should, however, be understood that the apparatus 1 may comprise additional features that are not illustrated. The electronic apparatus 1 may be, for example, a personal computer, a personal digital assistant, a mobile cellular telephone, a personal music player, or any other electronic apparatus that enables a user to access stored content such as stored audio files. The electronic apparatus 1 may be a handheld apparatus 1 which can be carried in a user's hand, handbag or pocket for example.

The illustrated electronic apparatus 1 comprises: a user interface 9 and a controller 4. In the illustrated embodiment the controller 4 comprises a processor 3 and a memory 5.

The controller 4 may be implemented using instructions that enable hardware functionality, for example, by using executable computer program instructions 8 in a general-purpose or special-purpose processor 3 that may be stored on a computer readable storage medium (e.g. disk, memory etc) to be executed by such a processor 3.

The processor 3 is configured to receive input commands from the user interface 9 and to provide output commands to the user interface 9. The processor 3 is also configured to write to and read from the memory 5.

In the illustrated embodiment the user interface 9 comprises a display 11, a user input device 13 and an audio output device 15. The user input device 13 may comprise a touch sensitive user input device such as a touch sensitive display configured to enable a user to make inputs via the display 11. The user input device 13 may also comprise a touch pad, a key pad, a joy stick or any other user input device which enables a user to input information into the apparatus 1.

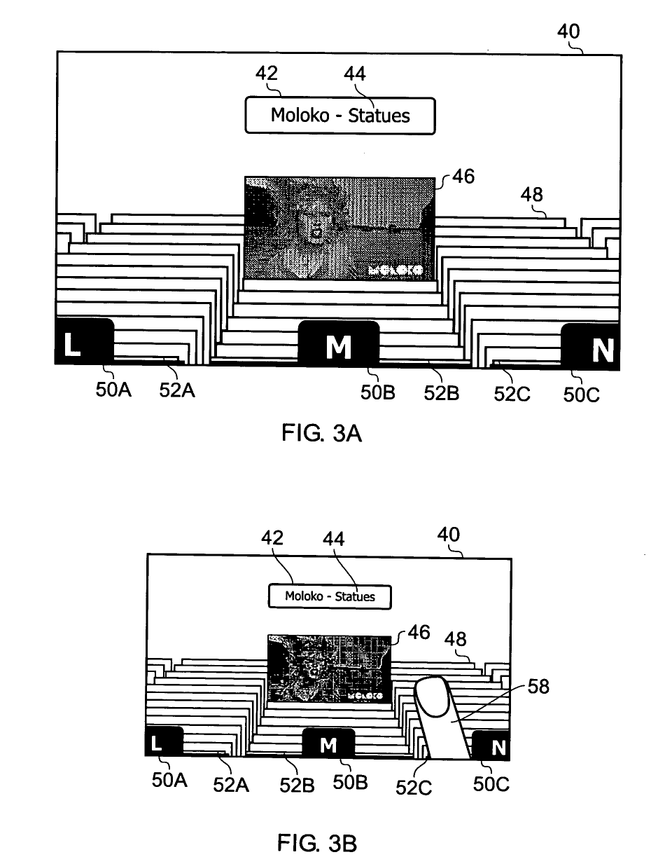

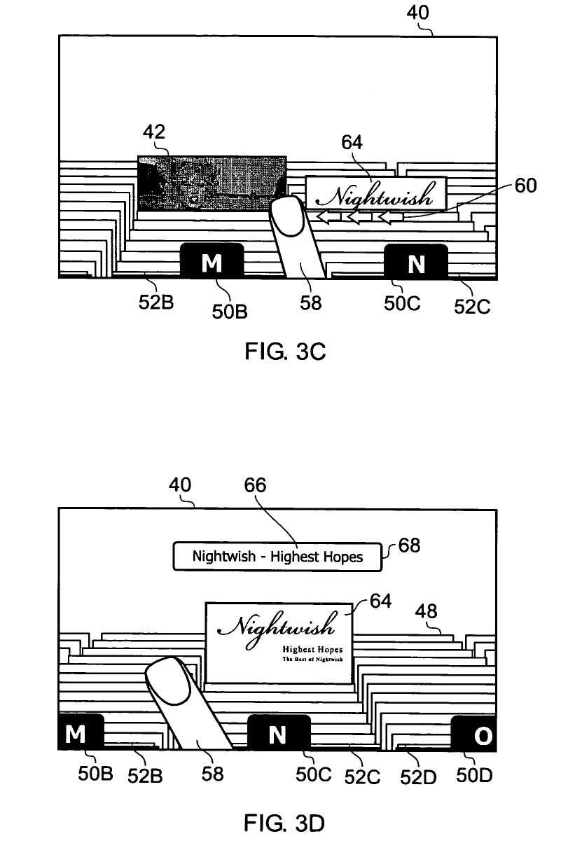

The display 11 is configured to present a graphical user interface 40 to a user. Examples of a graphical user interfaces according to various embodiments of the invention are illustrated in FIGS. 3 to 5.

The audio output device 15 may be, for example, a loudspeaker. The audio output device 15 may be configured to output audio information. The audio information may be audio content 10 such as music files 10 which are stored in the memory 5. In other embodiments the audio information may be content which is received by the apparatus 1.

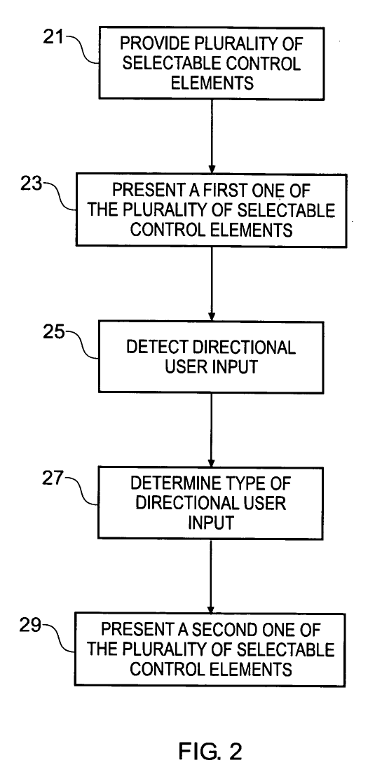

The memory 5 stores a computer program 7 comprising computer program instructions 8 that control the operation of the apparatus 1 when loaded into the processor 3. The computer program instructions 8 provide the logic and routines that enables the apparatus 1 to perform the method illustrated in FIG. 2. The processor 3 by reading the memory 5 is able to load and execute the computer program 7.

The computer program instructions 8 may provide computer readable program means for controlling the display 11 to present a first one 42 of a plurality of selectable control elements 42 where the plurality of selectable control elements 42, 64, 72 are sorted into categories according to a first sorting criterion and sorted into positions within the categories according to a second sorting criterion and where the first one 42 of the plurality of selectable control elements is positioned in a determined category at a determined position within the determined category. The computer program instructions 8 may also provide computer readable program means for controlling the display 11 to present a second one 64, 72 of the plurality of selectable control elements by selecting, in response to a first type of directional user input, a different category and selecting, in response to a second type of directional user input, a position within the selected category without changing the selected category.

The computer program 7 may arrive at the apparatus 1 via any suitable delivery mechanism 19. The delivery mechanism 19 may be, for example, a computer-readable storage medium, a computer program product, a memory device, a record medium such as a CD-ROM or DVD, an article of manufacture that tangibly embodies the computer program 7. The delivery mechanism 19 may be a signal configured to reliably transfer the computer program 7. The apparatus 1 may propagate or transmit the computer program 7 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

A method of controlling the apparatus 1, according to embodiments of the present invention, is illustrated schematically in FIG. 2.

At block 21 a plurality of selectable control elements 42, 64, 72 are provided by the apparatus 1. Each selectable control element 42, 64, 72 enables access to a piece of content. For example each selectable control element 42, 64, 72 may be associated with audio information stored in a music file so that when a selectable control element is selected the corresponding audio information is output via the audio output device 15.

The plurality of selectable control elements 42, 64, 72 are sorted into categories according to a first sorting criterion and sorted into positions within the categories according to a second sorting criterion.

In some embodiments of the invention the criterion used for sorting may be selected by a user of the apparatus 1 so that the selectable control elements 42, 64, 72 are ordered in a manner which is most convenient for the user. In other embodiments the sorting criterion used may be predetermined by the processor 3 or the computer program instructions 8.

The first sorting criterion may be different to the second sorting criterion. For example the first sorting criterion may be the genre of the content, so that all selectable control elements 42, 64, 72 of the same style are grouped together. The second sorting criterion may be alphabetical order of a label 44, 66, 74, associated with the selectable control element so that the selectable control elements 42, 64 are ordered within the category in a manner which enables a user to easily locate the selectable control element they are looking for.

Alternatively the second sorting criterion may be a subset of the first sorting criterion so that the first sorting criterion orders the plurality of selectable control elements 42, 64, 72 on a first scale and the second sorting criterion orders the plurality of selectable control elements 42, 64, 72 on a second, smaller scale. For example, the first sorting criterion could be the alphabetical order of a label 44, 66, 74 associated with the selectable control element so that selectable control elements with a label 44, 66, 74 starting with the same letter are in the same category. The second sorting criterion could then be the alphabetical order of the remaining characters in the labels 44, 66, 74 so that the selectable control elements are ordered alphabetically within the category.

At block 23 a first one 42 of the plurality of selectable control elements is presented on the display 11. The first selectable control element 42 may comprise an image 46 indicative of the content associated with the first selectable control element 42. For example where the content is a music album the image 46 may be the album cover. In some embodiments the image 46 may be an image which has been selected by a user of the apparatus 1. A generic image may be used where no image has been selected or where the album cover is not available.

The first selectable control element 42 may also comprise a label 44 indicative of the content associated with the first selectable control element 42. For example, where the content is a music album the label 44 may indicate the artist and the title of the album. The label 44 may be presented on the display 11 adjacent to the image 46.

When the first selectable control element 42 is presented 23 on the display 11 the apparatus 1 is configured to enable a user to select the first selectable control element 42 using the user input device 13.

In some embodiments of the invention the first selectable control element 42 may be the only selectable control element presented 23 on the display 11. In other embodiments other selectable control elements may be presented but less prominently than the first selectable control element 42. For example the first selectable control element 42 may be presented 23 in the centre of the display 11 whereas the other selectable control elements may be presented towards the edges of the display 11 and they may be presented smaller or only a portion of the other selectable control elements may be presented.

The display 11 may also be configured to present an image 48 which provides an indication of the category in which the first selectable control element 42 is positioned. The image 48 may also indicate the position of the first selectable control element 42 within the category.

At block 25 the processor 3 detects that a directional user input is being made via the user input device 13. In embodiments of the invention where the display 11 is a touch sensitive display the directional user input may be a trace input across the surface of the display 11. In other embodiments the directional user input may be an input made using a joystick or a roller key or a multi directional key.

At block 27 the processor 3 determines the type of directional user input which has been made, for example, where the directional user input is a trace input made via the display 11 the processor 3 will determine the general direction in which the trace was made. In embodiments where the directional user input is made by pushing a joystick or a roller key the processor 3 will determine the direction in which the joystick or roller key was pushed. In embodiments where the directional user input is made by actuating a multi directional key the processor 3 will determine which of the directions was actuated.

The type of directional user input made will determine whether a new category is selected or whether a new position within the category is selected. For example a first type of directional user input will select a new category. When a new category is selected the selected position in the category may remain unchanged or the selected position may be changed to a default position within the category, for example, it may automatically default to the first position within the category.

A second type of directional input will enable a new position within a category to be selected but would not change the category itself. In some embodiments when the last position in a category is selected a directional input of the second type would cause the first position in the same category to be selected.

In embodiments where the display 11 is a touch sensitive display the first type of directional user input may be a trace input made in a first general direction and the second type of directional user input may be a trace input made in a second general direction. The second general direction may be perpendicular or approximately perpendicular to the first general direction.

Similarly, in embodiments where the directional user input is made by pushing a joystick or a roller key the first type of directional user input may be pushing the joystick or roller key towards a first general direction and the second type of directional user input may be pushing the joystick or roller key towards a second general direction and the second general direction may be perpendicular or approximately perpendicular to the first general direction.

In embodiments where the directional user input is made by actuating a multi directional key the first type of directional user input may be actuating a first direction of the multi directional key and the second type of directional user input may be actuating a second direction of the multi directional key. The second direction may be perpendicular or approximately perpendicular to the first direction.

The processor 3 may also determine the magnitude of the directional user input. For example, where the directional user input is a trace input made via the display 11 the processor 3 will determine the length of the trace across the display 11. Where the directional user input is pushing a joystick or a roller key the processor 3 may determine the length of time for which the input was made. Where the directional user input is actuation of a multi directional key the processor 3 may determine the length of time for which the key was actuated or the number of times the key was actuated. The magnitude of the directional user input will determine which category or position within a category is selected.

At block 29, in response to the detected directional user input, the processor 3 will select the new category and/or position within the category and will control the display 11 to present a second selectable control element 64 corresponding the new selected category and/or position within the category.

The second selectable control element 64 may replace the first selectable control element 42 on the display 11 so that the first selectable control element is no longer presented.

In some embodiments of the invention the second selectable control element 64 may only be presented 29 once the processor 3 has detected that the directional user input has been completed. In other embodiments of the invention blocks 27 and 29 may be repeated contemporaneously with the user input being made so that the selectable control element displayed changes as the user is making the input.

The blocks illustrated in FIG. 2 may represent steps in a method and/or sections of code in the computer program 7. The illustration of a particular order to the blocks does not necessarily imply that there is a required or preferred order for the blocks and the order and arrangement of the blocks may be varied. Furthermore, it may be possible for some steps to be omitted.

FIGS. 3A to 3D illustrate a method of controlling the display 11 to change the selectable control element presented according to a first embodiment of the invention.

FIG. 3A illustrates a graphical user interface 40 which may be presented on the display 11. In the described specific embodiment the display 11 is a touch sensitive display which enables touch inputs to be made via actuation of the surface of the display 11.

The graphical user interface 40 comprises a first selectable control element 42. The first selectable control element 42 enables access to an album comprising a plurality of individual songs. The first selectable control element 42 comprises an image 46 and a label 44. The image 46 is the cover of the album which the first selectable control element 42 enables access to. The label 44 indicates the artist of the album and the title of the album. In the illustrated example the artist is Moloko and the title of the album is Statues. A user may access the Moloko album by selecting the first selectable control element 42 when it is presented on the display.

The first selectable control element 42 is presented in the centre of the display 11. The label 44 is presented adjacent to the image 46. In the illustrated embodiment the image 46 is only part of the album cover, in other embodiments the image 46 may comprise the entire album cover.

The graphical user interface 40 also comprises an image 48 which represents some of the plurality of selectable control elements 42, 64, 72. In the illustrated embodiment the plurality of selectable control elements are presented as boxes arranged in columns 52A, 52B and 52C according to their respective categories. A label 50A, 50B and 50C is presented adjacent to each column to indicate the category associated with that column.

In the illustrated embodiment three columns 52A, 52B and 52C are presented in the image 48. This represents only a portion of the available categories. In other embodiments a different number of columns may be presented in the image 48. The user may be able to configure the apparatus 1 to increase or decrease the number of columns presented in the image 48.

In the illustrated embodiments the image 48 representative of the plurality of the selectable control elements is presented so that the plurality of columns 52A, 52B and 52C extend horizontally across the display 11. In other embodiments the plurality of columns 52A, 52B and 52C may be presented on the display at an angle so that they appear to extend into the display 11. This may enable a larger number of columns to be presented on the display 11.

In the illustrated embodiment the first sorting criterion is alphabetical order of the labels associated with the selectable control elements so the label of each of selectable control elements in each of the categories begins with the same letter. The graphical user interface 40 illustrated in FIG. 3A comprises three columns 52A, 52B, 52C. The left hand side column 52A represents the category of selectable control elements with a label beginning with the letter L, the middle column 52B represents the category of selectable control elements with a label beginning with the letter M and the right hand side column 52C represents the category of selectable control elements with a label beginning with the letter N. Other categories may be provided but are not presented on the display 11.

The first selectable control element 42 is in the middle column 52B because the initial letter of the label 44 is M.

In the specific embodiment illustrated in FIG. 3A the image 48 does not comprise any information about the other selectable control elements or the content associated with them. The first selectable control element 42 is the only selectable control element which can be selected from the graphical user interface in FIG. 3A.

In FIG. 3B the user has started to make a directional user input by actuating the touch sensitive display 11 with their finger 58. In some embodiments of the invention the user may actuate the touch sensitive display 11 by physically making contact with the surface of the display 11 with their finger 58 or any other suitable object such as a stylus. In other embodiments the user may be able to actuate the touch sensitive display 11 simply by bringing their finger or stylus close to the surface of the display 11.

The user has started to make the input by actuating the area of the display 11 to the right of the first selectable control element 42 where the right hand column 52C of selectable control elements is presented.

As the user has only just initiated the input the first selectable control element 42 is still presented on the display 11 in FIG. 3B.

The user then makes a trace input, as illustrated in FIG. 3C, by dragging their finger 58 across the surface of the display 11 towards the left hand side of the display 11 in the direction indicated by the arrows 60.

As the trace input is being made the processor 3 determines 27 the direction of the trace input and selects a category and/or position in a category accordingly. As the trace illustrated in FIG. 3C is being made horizontally across the display, the processor 3 will determine this as a first type of directional user input and will select a new category.

The direction of the trace input will determine whether the new category selected is the category before the currently selected category or the category after the currently selected category. In the illustrated embodiment making a trace from right to left will select the category after the currently selected category and so in FIG. 3B the first selectable control element 42 from the M category is being replaced on the display 11 by a second selectable control element 64 from the N category which is the next category in alphabetical order. It is to be appreciated that a trace input in the opposite direction, from left to right, would have selected the preceding category, the L category.

In the embodiment illustrated in FIG. 3C the first directional user input only changes the selected category. The position within the category does not change, so for example, the sixth selectable control element in the M category is replaced with the sixth selectable control element in the N category.

In the illustrated embodiment the processor 3 controls the display 11 so that the first selectable control element 42 is gradually replaced on the display 11 by the second selectable control element 64. This may provide visual feedback to the user as they are making the inputs and also make the apparatus 1 more visually appealing. For example, in FIG. 3C the label 44 of the first selectable control element 42 is no longer displayed once the processor 3 has begun to detect the trace input and the image 46 of the first selectable control element 42 appears to move downwards into the image 48 representative of the plurality of selectable control elements while the image 68 of the second selectable control element 64 appears to move upwards out of the image 48 representative of the plurality of selectable control elements. The image of the selectable control elements is moved along the display 11 in the direction that the trace is being made so that the M column 52B is no longer displayed in the middle of the display 11.

In FIG. 3D the user has completed the trace input. The user's finger 58 is now positioned towards the left had side of the display 11. The first selectable control element 42 is no longer presented on the display and instead the second selectable control element 64 is presented 29 in its place. The second selectable control element 64 also enables access to an album comprising a plurality of individual songs and comprises an image 68 and a label 66 where the image 68 is the cover of the album and the label 66 indicates the artist of the album and the title of the album. In the illustrated example the artist is Nightwish and the title of the album is Highest Hopes.

The second selectable control element 64 is now presented 29 in the centre of the display 11. As with the first selectable control element the label 66 is presented adjacent to the image 68 and the image 46 is only part of the album cover.

The image 48 which represents some of the plurality of selectable control elements has been shifted in response to the trace input so that the N column 52C is now presented in the middle of the display 11 while the M column 52B is on the left hand side and the O column 52D and label 50D indicating that it is the O column is on the right hand side of the display 11. The L column 52A is no longer presented.

As the second selectable control element 64 is now presented on the display the user of the apparatus can access the Nightwish album by selecting this selectable control element 64.

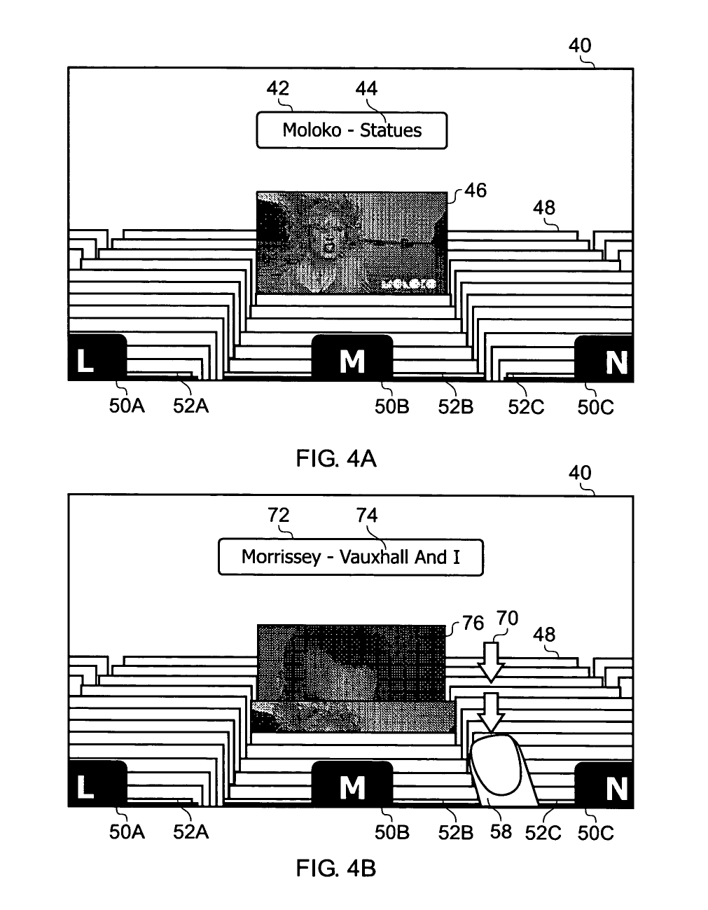

FIGS. 4A to 4B illustrate a method of controlling the display to change the selectable control element presented according to a second embodiment of the invention.

FIG. 4A illustrates the same user interface as illustrated in FIG. 3A. In FIG. 4B a user is making a second type of directional user input which in the illustrated embodiments of the invention is a trace input across the surface of the display 11 in a direction which is generally perpendicular to the first type of directional user input. In the example illustrated in FIG. 4B the directional user input is made by actuating the display 11 with their finger 58 and then moving their finger 58 towards to the lower edge of the display 11 as indicated by the arrows 70.

As the trace input is being made the processor 3 will determine 27 that the trace input is a second type of directional user input and will select a new position within the currently selected category, without changing the selected category.

The direction of the trace input will determine whether the new position selected is the position before the currently selected position or the position after the currently selected position. In the illustrated embodiment making a trace in a direction towards the lower edge of the display 11 will select the position after the currently selected position and so in FIG. 4B the first selectable control element 42 is being replaced on the display 11 by a second selectable control element 72 which has the next position in the category. It is to be appreciated that a trace input in the opposite direction, that is, towards the upper edge of the display 11, would have selected the preceding position.

In the particular embodiment illustrated the selectable control elements are organized in alphabetical order within each category so that the next selectable control element in the category after the selectable control element 42 which enables access to the Moloko album is the selectable control element 72 which enables access to the Morrissey album titled Vauxhall and I.

In the embodiment illustrated in FIG. 4B the processor 3 controls the display 11 so that the first selectable control element 42 is gradually replaced on the display 11 by the second selectable control element 72. The label 44 of the first selectable control element 42 is no longer displayed and the image 46 of the first selectable control element 42 appears to move downwards into the image 48 representative of the plurality of selectable control elements while the image 76 of the second selectable control element 74 appears to move upwards out of the image 48 representative of the plurality of selectable control elements. The label 44 of the first selectable control element 42 is replaced on the display by the label 74 of the second selectable control element 72.

As the category does not change when the second type of user input is made there is no movement of the image 48 representative of the plurality of selectable control elements.

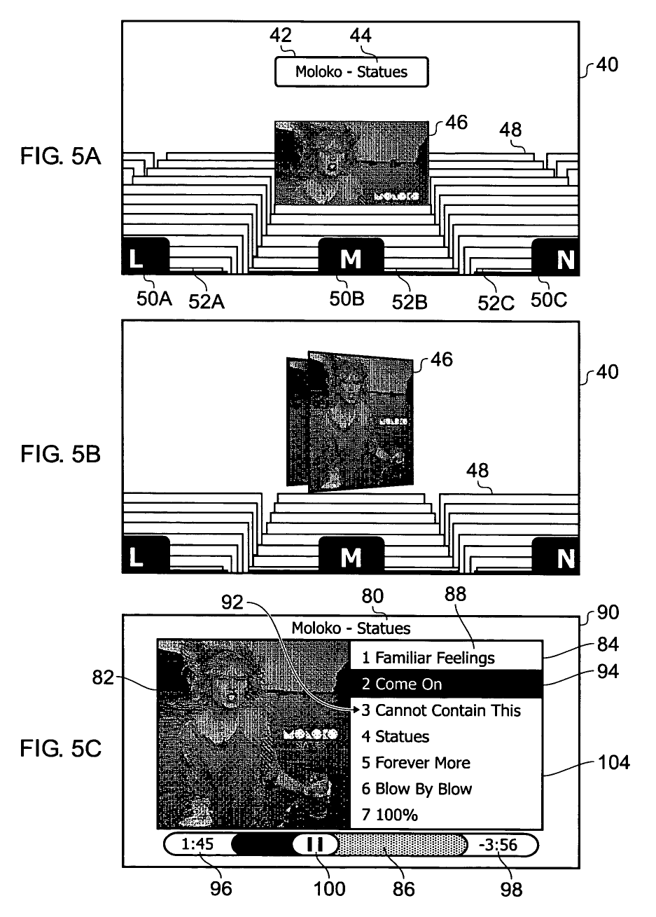

FIGS. 5A to 5C illustrate a method of enabling access to content according to an embodiment of the invention. The graphical user interface 40 presented in FIG. 5A is the same as that presented in FIGS. 3A and 4A.

A user may enable access to the content associated with the first selectable control element 42 by selecting the first selectable control element 42. In embodiments of the invention where the display 11 is a touch sensitive display 11 a user may select a selectable control element by actuating a designated area of the display 11. The designated area of the display 11 may be the area in which the selectable control element is displayed. In other embodiments the selectable control element may be selected by using different user input means such as a particular key in a keypad.

In response to user selection of the first selectable control element 42 the processor 3 will configure the display 11 to present the graphical user interface 40 illustrated in FIG. 5B.

In the graphical user interface 40 illustrated in FIG. 5B the image 46 of the first selectable control element 42 is presented in its entirety in the centre of the display 11 and the image 48 representing the plurality of selectable control elements is moved toward the lower edge of the display 11 so that only the top edge of this image 48 is presented. The graphical user interface 40 in FIG. 5B may be used to provide visual feedback to the user as the content associated with the selected control element is retrieved from the memory 5 or is accessed from a remote location.

Once the content has been accessed the audio information is output using the audio output means 15 and, at the same time, the graphical user interface 40 illustrated in FIG. 5C is presented on the display 11. The graphical user interface 40 in FIG. 5C comprises an enlarged image 82, an enlarged label 80, information 84 relating to the content and a control bar 86.

The enlarged label 80 is presented at the top of the display 11 and comprises the name of the recording artist and the title of the album. The enlarged image 82 is the same image 46 which comprises part of the first selectable control element 42, that is, it is the album cover however the image 82 is now presented in its entirety.

The enlarged image 82 is presented adjacent to the information 84 relating to the content. In the illustrated embodiment the information 84 is a list 88 of the songs on the album. A scroll bar 90 is presented adjacent to the list 88. The scroll bar 90 may be used to enable a user to scroll through the list 88 in embodiments where the entire list cannot be displayed at once.

The list 88 may be presented on a background 104 which is associated with the image 82. For example, in the embodiment illustrated in FIG. 5 the background 104 is a blurred version of a portion of the image 82. In other embodiments the background 104 could be images from the reverse of the album cover.

An arrow 92 is presented adjacent to the currently playing song which in the embodiment illustrated in FIG. 3 is the third song in the list 88. The second song on the list 88 is highlighted as the background 94 to this song is a different colour to the rest of the background. A user may be able to highlight other songs, either by using the scroll bar 90 or by actuating the area of the display 11 in which the title of the song is presented. In some embodiments of the invention a user may be able to stop the currently playing song and start another song by making a double tap input in the area of the display 11 in which the title of the another song is displayed.

A first number 96 is presented to the left of the control bar 86 to provide an indication of the amount of the currently playing song which has been played and the second number 98 is presented to the right of the control bar 86 to provide an indication of the amount of the song remaining.

The control bar 86 comprises a handle 100 and the position of the handle 100 along the control bar 86 also provides an indication of the amount of the currently playing song which has been played and the amount of the song remaining. The handle 100 may be moved along the control bar to rewind or fast forward through the song. Also actuating the handle 100 when a song is playing will pause the song and actuating the handle when a song is not playing will start playing the song again. When no songs are playing but a song is highlighted, actuating the handle 100 will start playing the highlighted song.

As the handle 100 of the scroll bar and/or a double tap input can be used to start and stop the song playing there is no requirement for a separate play/pause button to be provided. This reduces the amount of user input devices needed. This is particularly advantageous where the display 11 is a touch sensitive display 11 as the image 82 on the display can be larger and more of the list 88 can be displayed.

Although embodiments of the present invention have been described in the preceding paragraphs with reference to various examples, it should be appreciated that modifications to the examples given can be made without departing from the scope of the invention as claimed. For example in the above described example the selectable control elements are associated with audio content, in other embodiments the content may be visual content such as videos.

Also in the above described embodiments the sorting criteria used is alphabetical order. It is to be appreciated that other types of sorting criterion may be used for example the selectable control elements may be ordered according to the time and date each selectable control element was created or they may be ordered by genre or the type of content associated with each selectable control element.

In some embodiments of the invention a list of categories may be presented on the display 11 and a user may also be able to select a category by selecting an item from the list. For example, in embodiments where the first sorting criterion is alphabetical order the list may comprise the letters of the alphabet or some of the letters of the alphabet. A user may be able to select a letter from the list by actuating the user input device 13, for example by actuating a portion of a touch sensitive display or by actuating a key in a keypad. In response to the selection of the letter the category associated with that letter will be selected and the display 11 will be configured to present a selectable control element from the selected category. This may enable a user to quickly select a particular category and reduce the number of user inputs required to select a particular selectable control element.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
providing a plurality of selectable control elements where the plurality of selectable control elements are sorted into categories according to a first sorting criterion and sorted into positions within the categories according to a second sorting criterion;
controlling a display to present a first one of the plurality of selectable control elements wherein the first one of the selectable control elements is positioned in a determined category at a determined position within the determined category;
enabling a user to control the display to present a second one of the plurality of selectable control elements by enabling a first type of directional user input to select a different category and enabling a second type of directional user input to select a position within the selected category without changing the selected category.

2. A method as claimed in claim 1 wherein the selectable control element enables access to content.

3. A method as claimed in claim 2 wherein the content comprises audio information.

4. A method as claimed in claim 2 wherein the selectable control elements comprise an image corresponding to the content.

5. A method as claimed in claim 2 wherein the selectable control elements comprise a label indicative of the content associated with selectable control element and the first sorting criterion is alphabetical order of the first character in the label.

6. A method as claimed in claim 5 wherein the second sorting criterion is the alphabetical order of second and subsequent characters in the label.

7. A method as claimed in claim 2 wherein in response to selection of a selectable control element information relating to the content associated with the selectable control element is presented.

8. A method as claimed in claim 2 wherein the directional inputs are trace inputs on a touch sensitive user input device.

9. An apparatus comprising:
a display configured to present a first one of a plurality of selectable control elements where the plurality of selectable control elements are sorted into categories according to a first sorting criterion and sorted into positions within the categories according to a second sorting criterion and where the first one of the plurality of selectable control elements is positioned in a determined category at a determined position within the determined category;
a user input device configured to enable a user to make directional user inputs; and
a processor configured to control the display to present a second one of the plurality of selectable control elements by selecting, in response to a first type of directional user input, a different category and selecting, in response to a second type of directional user input, a position within the selected category without changing the selected category.

10. An apparatus as claimed in claim 9 wherein the selectable control elements enable access to content.

11. An apparatus as claimed in claim 10 wherein the content comprises audio information.

12. An apparatus as claimed in claim 10 wherein the selectable control elements comprise an image corresponding to the content.

13. An apparatus as claimed in claim 10 wherein the selectable control elements comprise a label indicative of the content associated with the selectable control element and the first sorting criterion is alphabetical order of the first character in the label.

14. An apparatus as claimed in claim 13 wherein the second sorting criterion is the alphabetical order of the second and subsequent characters in the label.

15. An apparatus as claimed in claim 10 wherein in response to selection of a selectable control element information relating to the content associated with the selectable control element is presented.

16. An apparatus as claimed in claim 9 wherein the directional inputs are trace inputs on a touch sensitive user input device.

17. A computer program comprising program instructions for controlling an apparatus, the apparatus comprising a user input device configured to enable a user to make directional user inputs and a display, the program instructions providing, when loaded into a processor:
means for controlling the display to present a first one of a plurality of selectable control elements where the plurality of selectable control elements are sorted into categories according to a first sorting criterion and sorted into positions within the categories according to a second sorting criterion and where the first one of the plurality of selectable control elements is positioned in a determined category at a determined position within the determined category; and
means for controlling the display to present a second one of the plurality of selectable control elements by selecting, in response to a first type of directional user input, a different category and selecting, in response to a second type of directional user input, a position within the selected category without changing the selected category.

18. A physical entity embodying the computer program as claimed in claim 17.

19. An electromagnetic carrier signal carrying the computer program as claimed in claim 17.

20. A computer program comprising program instructions for causing a computer to perform the method of claim 1.

21. A user interface comprising:
a display configured to present a first one of a plurality of selectable control elements where the plurality of selectable control elements are sorted into categories according to a first sorting criterion and sorted into positions within the categories according to a second sorting criterion and where the first one of the plurality of selectable control elements is positioned in a determined category at a determined position within the determined category;
a user input device configured to enable a user to make directional user inputs;
wherein the user interface is configured such that the display is controlled to present a second one of the plurality of selectable control elements by selecting, in response to a first type of directional user input, a different category and selecting, in response to a second type of directional user input, a position within the selected category without changing the selected category.

22. A user interface as claimed in claim 21 wherein the selectable control elements enable access to content.

23. A user interface as claimed in claim 22 wherein the content comprises audio information.
